(19) United States
(12) Patent Application Publication
(10) Pub. No.: US 2018/0005663 A1
(43) Pub. Date: Jan. 4, 2018

(54) METHOD AND APPARATUS FOR DYNAMIC MODE MEMORY TESTING

(71) Applicant: QUALCOMM Incorporated, San Diego, CA (US)

(72) Inventors: Praveen Raghuraman, Chennai (IN); Nikhil Sudhakaran, Palakkad (IN)

(21) Appl. No.: 15/197,588

(22) Filed: Jun. 29, 2016

(51) Int. Cl. G11B 20/18

(52) U.S. Cl. CPC G11B 20/1816

(57) ABSTRACT

A method and apparatus for dynamic memory mode testing is provided. The method begins when an electronic device is reset before testing begins. A BIST mode is selected and then input to a BIST apparatus. The BIST mode is then performed and test results recorded. An additional BIST mode is then selected and testing using the additional BIST mode begins immediately. The apparatus includes a clock divider, a BIST controller in communication with the clock divider; a dynamic memory test module in communication with the clock divider, BIST controller and memory; and a low voltage test access port in communication with the BIST controller for receiving test output data from the BIST controller. The dynamic memory test module comprises: at least two AND gates in communication with at least three multiplexers.

### BACKGROUND

### Field

The present disclosure relates generally to wireless communication systems. More specifically the present disclosure related to methods and apparatus for dynamic mode memory testing.

### Background

Wireless communication devices typically use a system-on-chip (SoC) to provide many of the functions of the device. SoCs may also be used in many other electronic devices. A SoC is an integrated circuit that combines all components of a computer or other electronic system on a single chip. The SoC device may contain digital, analog, mixed-signal, and radio frequency (RF) functions on a single substrate. SoCs are used widely due to their low power consumption.

A SoC may consist of a microcontroller or digital signal processor (DSP) core, memory blocks including a selection of ROM, RAM, EEPROM, and flash memory, as well as timing sources. The timing sources may include oscillators and phase-locked loops (PLL). Peripherals, including counter-timers, real-time timers, and power-on reset generators may also be incorporated. A wide variety of external and internal interfaces including analog-to-digital converters (ADC), digital-to-analog converters (DAC), voltage regulators and power management circuits are also typically included in a SoC. The desired performance of the end device may result in different mixes of the above functions to be included in the SoC. The SoC also includes a bus system for connecting the various functional blocks.

Testing all of the SoC components is needed to ensure that all electronic devices incorporated into user devices function correctly. This testing may be time-consuming and expensive. Most SoCs have multiple memories which may cause increases in test time. Memory latency is the number of clock cycles requires for a memory to perform a read/write operation. This testing relies on memory built in test functions (BIST) and automatic test pattern equipment (ATE) to perform the testing.

Real time test scenarios involve dynamic mode changes for efficient testing. However, current ATE memory test flow involves a separate memory test for each mode. A mode may refer to a particular operation frequency or voltage, or combination of frequency and voltage. In this test flow the chip, or SoC, is reset and reconfigured for each change of mode for memory test frequency, memory automatic test pattern generation control center (ACC). Each of these tests requires a reset and reconfiguration of the chip, significantly increasing test time.

There is a need in the art for a method and apparatus that enables dynamic mode memory testing.

### SUMMARY

Embodiments described herein provide a method for dynamic memory testing. The method begins when an electronic device, such as a chip, is reset before testing begins. A BIST mode is selected and then input to a BIST apparatus. The BIST mode is then performed and test results recorded. An additional BIST mode is then selected and testing immediately switches to the newly selected BIST mode.

An additional embodiment provides an electronic device. The electronic device includes a clock divider in communication for dividing the frequency of a clock based on a selected BIST mode; a BIST controller in communication with the clock divider; a dynamic memory test module in communication with the clock divider, BIST controller and memory; and a low voltage test access port in communication with the BIST controller for receiving test output data from the BIST controller. The dynamic memory test module comprises: at least two AND gates in communication with at least three multiplexers.

A further embodiment provides an apparatus comprising: means for resetting an electronic device containing a memory to be tested; means for selecting a BIST mode, means for inputting the selected BIST mode to a BIST apparatus; means for performing the selected BIST mode and recording test results; means for selecting an additional BIST mode; and means for switching to an additional BIST mode; and means for switching to the additional BIST mode immediately after completion of the first BIST mode.

A yet further embodiment provides a non-transitory computer-readable medium, containing instructions, which when executed cause a processor to perform the following steps: resetting an electronic device containing a memory to be tested; selecting a BIST mode, inputting the selected BIST mode to a BIST apparatus; performing the selected BIST mode and recording test results; selecting an additional BIST mode; and switching to the additional BIST mode immediately after completion of the selected BIST mode.

### BRIEF DESCRIPTION OF THE DRAWINGS

FIG. 1 is a block diagram of a SoC, in accordance with embodiments disclosed herein.

FIG. 2 is a flow diagram of a real time test scenario without dynamic mode memory testing, in accordance with embodiments disclosed herein.

FIG. 3 is a flow diagram of a real time test scenario with dynamic mode memory testing, in accordance with embodiments disclosed herein.

FIG. 4 illustrates implementation of the dynamic memory test (DMT) apparatus at the SoC level, in accordance with embodiments disclosed herein.

FIG. 5 is a block diagram of the DMT apparatus, in accordance with embodiments disclosed herein.

FIG. 6 shows sample test results using the DMT apparatus, in accordance with embodiments disclosed herein.

FIG. 7 illustrates clock frequencies and ACC settings used with DMT testing at a nominal mode frequency, in accordance with embodiments disclosed herein.

FIG. 8 shows the clock frequencies and ACC settings used with DMT testing at a turbo mode frequency, in accordance with embodiments disclosed herein.

FIG. 9 shows the clock frequencies and ACC settings for a lower mode voltage test, the SVS mode frequency, in accordance with embodiments disclosed herein.

FIG. 10 illustrates the clock frequencies and ACC settings for a still lower mode voltage test, the SVS2 mode frequency, in accordance with embodiments disclosed herein.

FIG. 11 shows the test time savings provided by the DMT methodology, in accordance with embodiments disclosed herein.

FIG. 12 shows the vector memory savings provided by the DMT methodology, in accordance with embodiments disclosed herein.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as, but not limited to hardware, firmware, a combination of hardware and software, software, or software in execution. For example, a component may be, but is not limited to being, a process running on a processor, a processor, an object, an executable, a thread of execution, a program and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

As used herein, the term “determining” encompasses a wide variety of actions and therefore, “determining” can include calculating, computing, processing, deriving, investigating, looking up (e.g., looking up in a table, a database or another data structure), ascertaining and the like. Also, “determining” can include resolving, selecting choosing, establishing, and the like.

The phrase “based on” does not mean “based only on,” unless expressly specified otherwise. In other words, the phrase “based on” describes both “based only on” and “based at least on.”

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The various illustrative logical blocks, modules, and circuits described in connection with the present disclosure may be implemented or performed with a general purpose processor, a digital signal processor (DSP), an application specific integrated circuit (ASIC), a field programmable gate array (FPGA), or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described in connection with the present disclosure may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM, and so forth. A software module may comprise a single instruction, or many instructions, and may be distributed over several different code segments, among different programs and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A computer-readable medium may be any available medium that can be accessed by a computer. By way of example, and not limitation, a computer-readable medium may comprise RAM, ROM, EEPROM, CD-ROM or other optical disk storage, magnetic disk storage, or other magnetic storage devices, or any other medium that can be used to carry or store desired program code in the form of instructions or data structures and that can be accessed by a computer. Disk and disc, as used herein, includes compact disk (CD), laser disk, optical disc, digital versatile disk (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

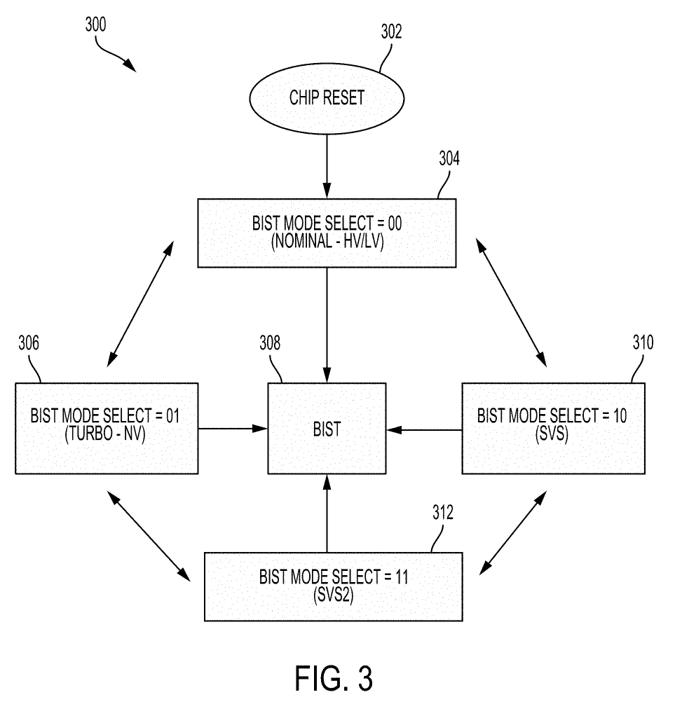

Further, it should be appreciated that modules and/or other appropriate means for performing the methods and techniques described herein, such as those illustrated by FIGS. 3-12, can be downloaded and/or otherwise obtained by a mobile device and/or base station as applicable. For example, such a device can be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a mobile device and/or base station can obtain the various methods upon coupling or providing the storage means to the device. Moreover, any other suitable technique for providing the methods and techniques described herein to a device can be utilized.

Embodiments described herein relate to a dynamic mode memory test method and apparatus. The method and apparatus facilitates dynamic mode changes between the modes to be tested. The apparatus provides real-time scenario testing on ATE and also provides internal hardware controls for each mode on the SoC. Internal hardware controls are provided for memory frequency, memory ACC setting, and test time multiplier.

A SoC is an integrated circuit that combines all components of a computer or other electronic system on a single chip. It may contain digital, analog, mixed-signal, and radio frequency (RF) functions. A SoC may consist of: a microcontroller or digital signal processor (DSP) core; memory blocks, including a selection of read-only memory (ROM), random access memory (RAM), electrically erasable programmable read-only memory (a type of non-volatile memory), and flash memory; timing sources including oscillators and phase-locked loops (PLL); peripherals including counter-timers, real-time timers, and power-on or reset generators; external interfaces; analog interfaces including analog to digital converters (ADC), digital to analog converters (DAC); voltage regulators; and power management circuits. A bus connects these blocks within the SoC.

Many SoCs incorporate an Acorn Risc Machine (ARM) proprietary processor into their architecture. A reduced instruction set computing (RISC) device may be used as a building block within a larger and more complex device, such as a SoC. The SoC may also use generic processors in place of the ARM. The processors may be configured for various environments. A RISC based design means that processors require significantly fewer transistors than a complex instruction set computing (CISC) device, such as those found in most personal computers. This approach results in lower cost, less heat production, and less power consumed. As a result, processors are used extensively in portable devices such as wireless devices and tablet, as well as in embedded systems. A processor uses a simpler design with more efficient multi-core central processing units (CPU).

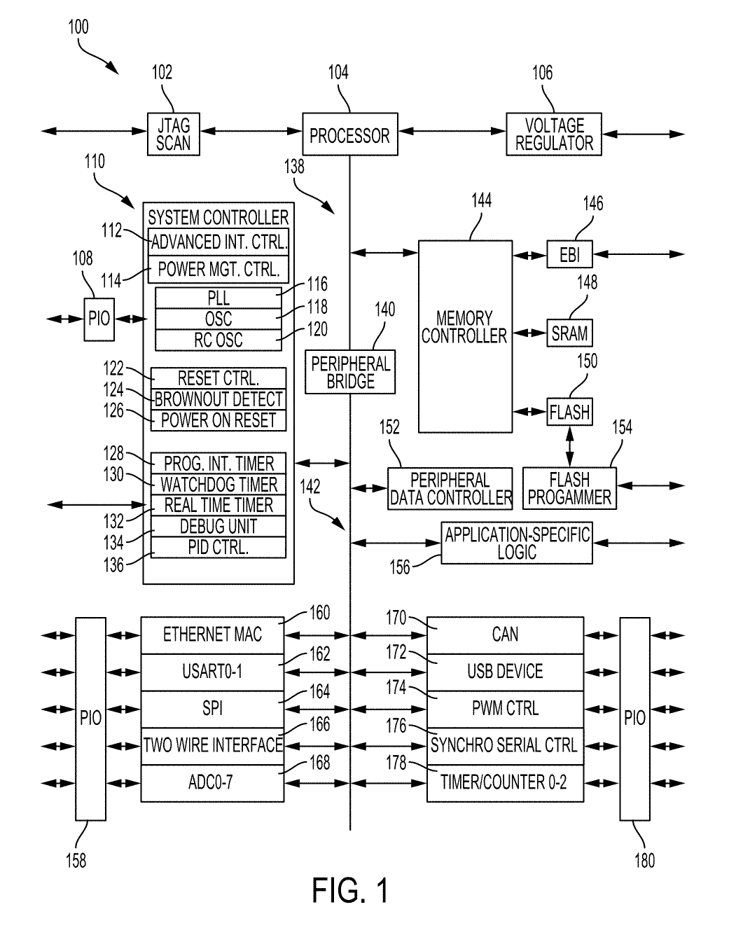

FIG. 1 illustrates a SoC, 100. The assembly 100 includes joint test action group (JTAG) scan device 102, which receives input signals for scanning. These signals are scanned before being sent to the processor 104. The processor 104 may also send input to JTAG scan device 102, which in turn may provide output. The processor also interfaces with voltage regulator 106. The SoC 100 may also incorporate a first peripheral input/output interface (PIO) 108. This PIO 108 interfaces with a system controller 110. System controller 110 may incorporate an advanced interface controller 112, a power management controller 114, a phase locked loop (PLL) 116, an oscillator 118, a resistor-capacitor (RC) oscillator 120, a reset controller 122, a brownout detector 124, a power on reset device 126, a program interrupt timer 128, a watchdog timer 130, a real time timer 132, a debug unit 134, and a proportional/integral/derivative (PID) controller 136. All of the devices under the control of system controller 110 interface through the PIO.

The processor 104 interfaces with peripheral bridge 140, which also provides input and output interface with the system controller 110. The peripheral bridge communicates with multiple components using an application peripheral bus (APB) 142. An internal bus 138 operates in conjunction with the peripheral bridge 140 to communicate with additional devices within the SoC 100. The internal bus 138 may be an application specific bus (ASP) or an application handling bus (AHB). Memory controller 140 interfaces with processor 104 using internal bus 138. The memory controller 140 also communicates with the external bus interface (EBI) 146. Memory controller 140 is also in communication with static random access memory (SRAM) 148, and flash memory 150. Flash memory 150 is in communication with flash programmer 154. The memory controller 144 is also in communication with peripheral data controller 152. Additional application specific logic 156 communicates with the internal bus 138 and may also have external connections. A second PIO 158 provides communication with an Ethernet medium access control (MAC) 160. The second PIO 158 also communicates with a universal asynchronous receiver/transmitter 162, a serial peripheral interface (SPI) 164, a two wire interface 166, and an analog to digital converter 168. These devices and interfaces connect through internal bus 138 with a controller area network bus (CAN) 170, a universal serial bus (USB) devices 172, a pulse width modulator (PWM) controller 174, a synchro serial controller 176, and a timer/counter 178. These devices, CAN 170, USB device 172, PWM controller 174, synchro serial controller 176 and timer/counter 178 interface with third PIO 180, which provides external input and output. While these elements are typical of many SoCs, other devices may be incorporated, and some may not be included.

Testing the SoCs is an important part of the manufacturing process. ATE is used to perform tests on the device, known as the device under test (DUT), using automation to quickly perform measurements and evaluate and record test results. An ATE may be a simple computer-controlled digital multimeter, or may be a more complex system with many instruments capable of testing and diagnosing faults in SoCs. ATE systems are designed to reduce amount of time needed to verify that a particular electronic device functions correctly, or to quickly find the faults before a device is installed in an end product, such as a wireless device. Typically, an ATE system consists of a master controller (often a computer) that synchronizes one or more capture instruments.

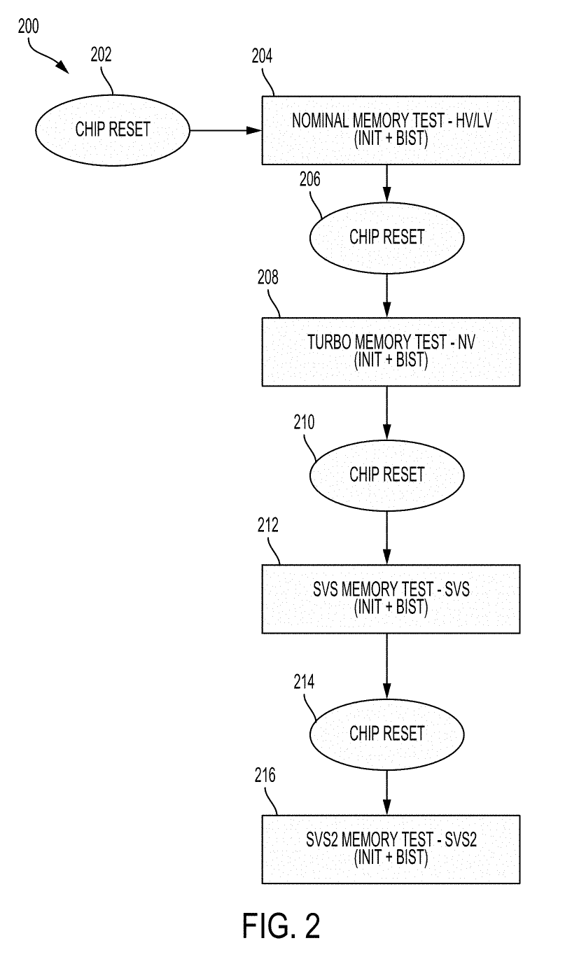

FIG. 2 illustrates the test flow that occurs in existing test methodologies and apparatus. The test flow 200 begins in block 202 when the chip, such as an SoC, is reset prior to testing. Once the chip is reset, the process moves to block 204 where a nominal memory test is performed. This nominal memory test may be performed at both a high voltage (HV) and a low voltage (LV). The test may be performed on initialization (INIT) and as part of the built-in self-test (BIST) process. Once the nominal memory testing is complete the process moves to block 206 where the chip is again reset before proceeding to the next test in block 208. Block 208 provides for a turbo memory test (Turbo) performed at a nominal voltage (NV). The Turbo test may refer to a higher frequency, and may be as high as 133 MHz in some chips. After Turbo mode testing in block 208 the process moves to block 210 where the chip is again reset in preparation for the next test. Block 212 provides for a static voltage scaling (SVS) mode memory test. This SVS memory test of block 212 may also be performed on INIT and BIST. The SVS mode may provide for a lower frequency, such as 50 MHz, and/or voltage combination. Following the SVS mode testing in block 212, the chip is again reset in block 214. After the reset of the chip in block 214, the process moves to an additional SVS2 memory test in block 216. As before, the SVS2 memory test may utilize a different frequency and/or voltage from the SVS testing performed in block 212. An example SVS2 frequency may be 37.5 MHz. The SVS2 memory testing may also be performed on INIT and BIST.

As the frequency of the mode decreases the BIST test time multiplier increases. As an example, the BIST test time multiplier for nominal, Turbo, and SVS modes may be 1.2, while the BIST test time multiplier for the lower frequency SVS2 mode may be 2.4. This doubling of the BIST test time multiplier represents a significant increase in test time and does not take into account the time already added for the numerous chip reset operations that are carried out in between the testing of the various modes.

FIG. 3 is a flow diagram of memory testing using the DMT apparatus described herein. The DMT apparatus and method facilitates dynamic mode changes during memory testing. The method 300 begins in block 302 where a chip reset occurs before testing is initiated. After the chip reset, a variety of testing modes may be entered. Modes are selected based on the specific features to be tested. An example of a mode that may be selected after the chip reset of block 302, is the BIST mode select 304, with a logic setting of 00. BIST mode select 304 allows testing at nominal voltage, as well as high voltage and low voltage settings. In addition to the voltage settings, a particular frequency may be used in BIST mode select 304. An additional mode that may be selected after chip reset block 302 is the BIST mode select 306, with a logic setting of 01. This mode provides for a turbo mode option, which may be used in conjunction with a nominal voltage. The turbo mode may use a higher frequency than the nominal mode of BIST mode 304. A further BIST mode select 310 may also be selected. BIST mode select 310 has a logic setting of 10 and may provide static voltage scaling (SVS). The BIST mode select 310 SVS may specify a lower frequency and a particular voltage setting. A further SVS mode, BIST mode SVS2, with a logic setting of 11 may also be used. In this mode, a still lower frequency and voltage may be specified.

Each of the BIST modes, 304, 306, 310, and 312 interface with the BIST testing apparatus 308. The BIST testing apparatus 308 provides the specific test programs used in the testing of the selected BIST modes. The DMT apparatus interacts with the BIST testing apparatus 308 to provide real-time testing on the ATE. Hardware internal to the DMT apparatus controls memory frequency, memory acceleration (ACC) settings for memory read/write operations. ACC settings have only two logical values, either a 0 or a 1. The DMT apparatus also controls the test time multiplier (TTM) used in the testing sequences. The TTM may also be considered to be BIST wait time.

An example of the values used in the dynamic memory mode testing of a power management integrated circuit (PMIC) is provided below.

| | BIST Mode | Frequency | | |
|---|---|---|---|---|
| Mode | Select | (MHz) | ACC | BIST TTM |
| Nominal | 00 | 100 | 0 | 1.2 |
| Turbo | 01 | 133 | 0 | 1.2 |
| SVS | 10 | 50 | 1 | 1.2 |
| SVS2 | 11 | 37.5 | 1 | 2.4 |

SoC testing may require testing of multiple memories and clock domains. Test results may be recorded during testing or may be downloaded from the BIST apparatus or may be stored in the ATE for retrieval after testing is complete.

The BIST mode selections may provide for specific test setups that enables the clocks and power to bring up a particular test block. These test blocks may be of varying sizes, and may vary across the different BIST memory modes. In the actual test, a test time multiplier is used to determine the time the test requires. The test time multiplier may reflect that some BIST mode selections may require additional test time. For example, testing at a lower frequency, such as in BIST mode select 310 and/or 312 for the SVS and SVS2 modes, may require additional test time.

The embodiments described herein provide for dynamic memory testing using the DMT apparatus. Dynamic-Mode Memory Testing (DMT) is enabled by the logic provided in the DMT apparatus. For example, block 304 BIST mode select at nominal voltage is selected by inputting the logic state 00 into the DMT. Similarly, for block 306, BIST mode select turbo, logic state 01 is input to the DMT. For SVS mode testing, in block 310, logic state 10 is input to the DMT. A second SVS mode, SVS2, found in block 312, is selected when logic state 11 is input to the DMT.

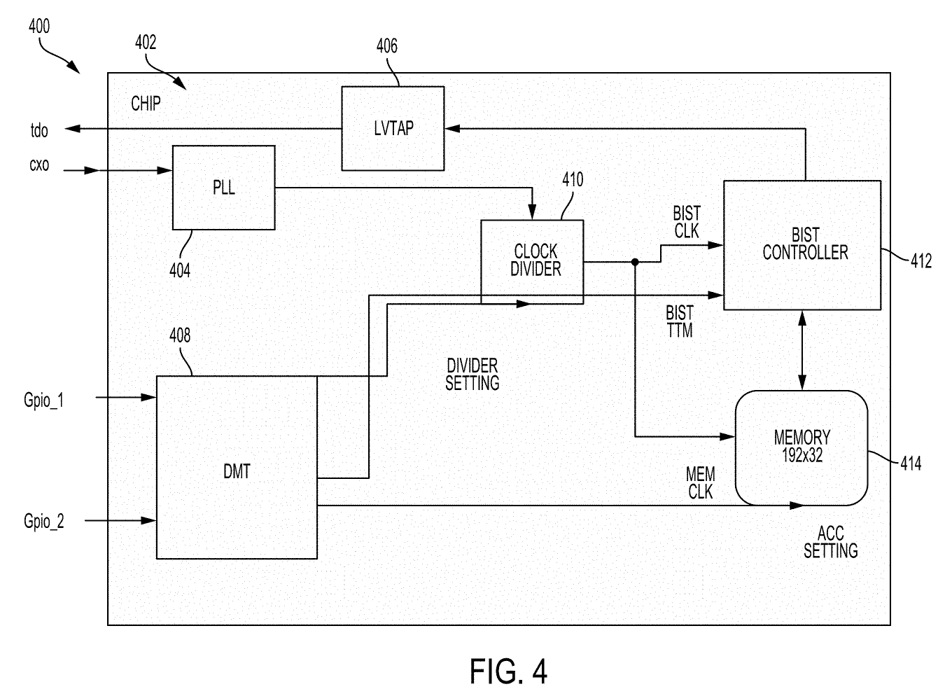

FIG. 4 illustrates implementation of the dynamic memory test (DMT) apparatus at the SoC level. The assembly 400 includes the chip 402. Chip 402 may be an SoC, but may also be any other chip level device. A phase locked loop (PLL) 404 receives input from a crystal oscillator, this input is designated cxo in FIG. 4. The crystal oscillator may be located in another core on the chip, or may be located off the chip or SoC. The PLL 404 is in communication with clock divider 410, which manages the clock functions for the chip or device. Clock divider 410 may input a BIST clock, designated BIST CLK on FIG. 4, to the BIST controller 412. The BIST CLK may have a clock frequency that is a division of a frequency of an input clock provided by the PLL 404 based on a divider setting provided by the DMT 408. The BIST CLK may also be input to memory 414 during testing. Clock divider 410 is in communication with BIST controller 412 and memory 414. Memory 414 may be the memory to be tested. BIST controller 412 is also in communication with memory 414. A low voltage test access port (LVTAP) 406 is also in communication with BIST controller 412. Test results may be routed from the BIST controller 412 to the LVTAP 406 to an output on the chip. These outputs may be designated as test data outputs and are shown on FIG. 4 as tdo. The DMT module 408 receives input from general purpose input/output ports, shown on FIG. 4 as GPIO. At least two GPIO inputs may be input to the DMT 408. The DMT 408 is connected to the BIST controller 412 and also to the memory 414. In operation DMT 408 provides a BIST CLK and BIST test time multiplier (BIST TTM) to the BIST controller 412. DMT 408 also provides a memory clock input, designated MEM CLK, to the memory 414.

Logic level assignments for the GPIO inputs are shown in the table below.

| Mode | GPIO 2 | GPIO 1 |
|---|---|---|
| Nominal | 0 | 0 |
| Turbo | 0 | 1 |
| SVS | 1 | 0 |
| SVS2 | 1 | 1 |

For a nominal voltage mode the GPIO 1 and GPIO 2 logic values are 0, reflecting the logic state selection of 00 for the nominal mode testing. The turbo mode testing provides for a logic level 1 for GPIO 1 and a logic level 0 for GPIO 2, again reflecting the turbo mode logic states. SVS mode testing uses a GPIO 1 logic level of 0 and a GPIO logic level of 1. SVS2 mode testing uses a GPIO 1 logic level of 1 and a GPIO logic level 2 of 1, which corresponds to the mode selection logic of 11.

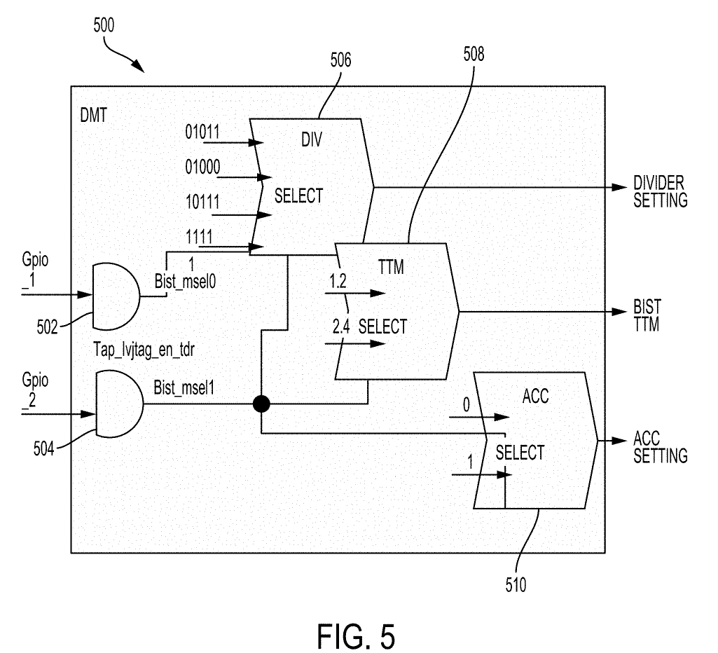

FIG. 5 is a block diagram of the DMT assembly 500. The DMT assembly receives input from two GPIO inputs, GPIO 1 and GPIO 2. GPIO 1 provides input to a first AND gate 502. GPIO 2 provides input to a second AND gate 504. First AND gate 502 is in communication with second AND gate 504. First AND gate 502 is in communication with first multiplexer 506. First AND gate 502 provides a BIST mode select signal (BIST_msel0) signal to the first multiplexer 506. BIST_msel0 and BIST_msel1 signals are internally generate signals that select the desired BIST mode. The BIST msel0 signal is also routed to second multiplexer 508, and third multiplexer 510. First multiplexer 506 provides a divider select function (DIV) to route incoming BIST mode select signals for processing appropriate to the selected mode. First multiplexer 506 receives four inputs, with each input corresponding to one of the possible BIST mode selections. The four input signals are: 01011, 01000, 10111, and 11111. The four signals provide the divider setting for the clock divider block 410 in FIG. 400. First multiplexer 506 outputs a divider setting as a result of this operation.

A test access port (TAP), shown between first AND gate 502 and second AND gate 504 provides an internally available signal. This signal may indicate that register programming is complete and that BIST dynamic mode memory testing may begin. This signal may use a low voltage and may be provided using a standard interface, such as the Joint Test Access Group (JTAG) test data register to provide standardized interfaces. This internally available signal is indicated as TAP_lvjtag_tdr in FIG. 5.

The divider multiplexer 506 divides the input frequency. An example of an input frequency that may be used is 600 MHz, however, depending on performance and the device being tested, other frequencies may be used. The four input signals 01011, 01000, 10111, and 11111 are the values that are programmed to facilitate dividing the input frequency and ensure that the desired output frequency is obtained. The table below provides an example, based on the 600 MHz frequency discussed above.

| | | Final Frequency at |
|---|---|---|
| Hex Value | Integer Divide | Memory (MHz) |
| 01000 | 4.5 | 133.33 |
| 01011 | 6 | 100 |
| 10111 | 12 | 50 |
| 11111 | 16 | 37.5 |

The specific logic is processed by the first multiplexer 506 to route the BIST mode selection for further processing within the DMT assembly 500. The first multiplexer 506 is in communication with second multiplexer 508 and third multiplexer 510. Second multiplexer 508 handles the TTM function indicated by the BIST mode select input from AND gate 502 as well as AND gate 504. AND gate 504 receives input from GPIO 2 and this signal is designated BIST mode select 1 (BIST_msel1). This BIST msel1 signal is also routed to first multiplexer 506, second multiplexer 508, and third multiplexer 510.

Second multiplexer 508 is responsible for selecting the TTM value, which is either 1.2 or 2.4. This value, depends on the frequency and voltage of the specific BIST mode selected, and is hardcoded for the memory tested. The output of the second multiplexer 508 is the BIST TTM setting needed for the test to be performed.

Third multiplexer 510 receives two inputs, 0 or 1. After processing the BIST mode select signal, the appropriate ACC setting is used to perform the test specified. The ACC setting provides instructions as to which automatic test pattern may be generated for use during testing.

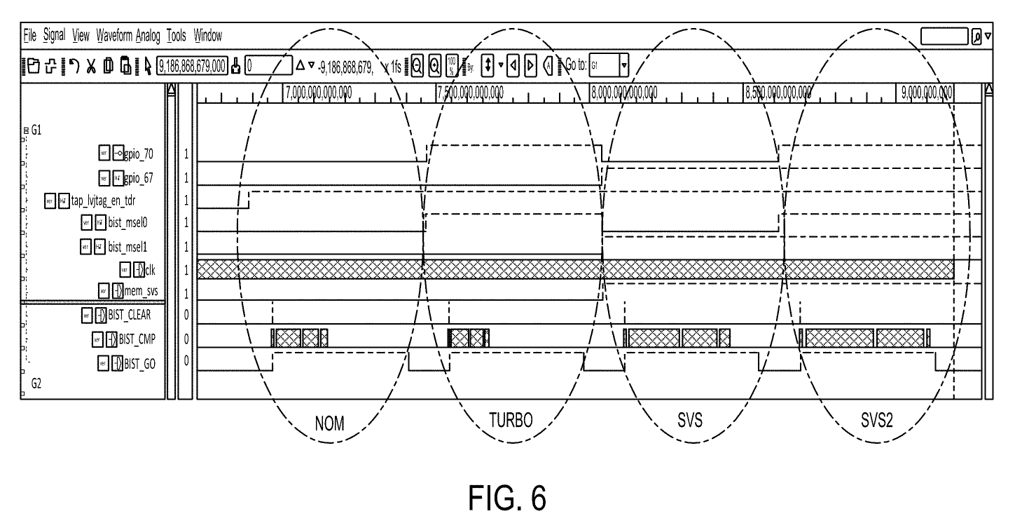

FIG. 6 illustrates sample test results using the DMT apparatus. A view of a typical test apparatus screen is shown. Each of the multiple modes is shown in the figure. The methodology of operation is apparent on the screen. Dynamic mode changes may be done on the fly in the ATE. After resetting the chip or device to be tested, a nominal initialization of the ATE may be performed. Following the nominal initialization, a BIST test in nominal mode may be run, followed immediately by a BIST turbo mode, a BIST SVS mode, and a BIST SVS2 mode. The changes between the modes are driven by the logic indications in the input signals to the DMT apparatus and mimic a real-time use scenario. Resetting and reconfiguring between the modes is not needed, which saves test time, as well as vector memory.

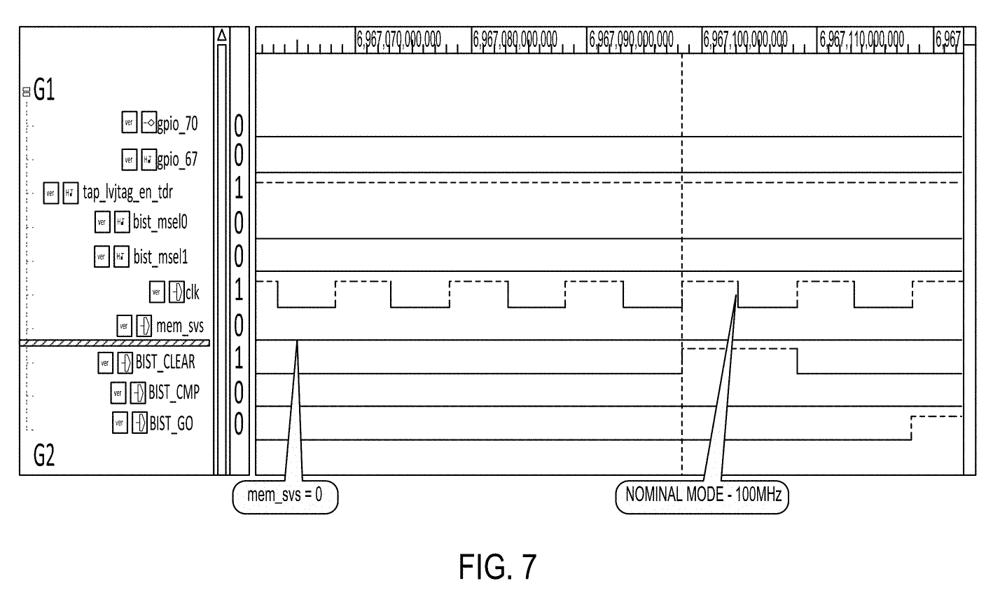

FIG. 7 provides additional details, specifically sample clock frequencies and ACC settings for the nominal mode. The embodiments described herein are not limited to the frequencies and modes shown. The frequencies and ACC settings may be varied depending on the functions that are to be tested and the specific device used.

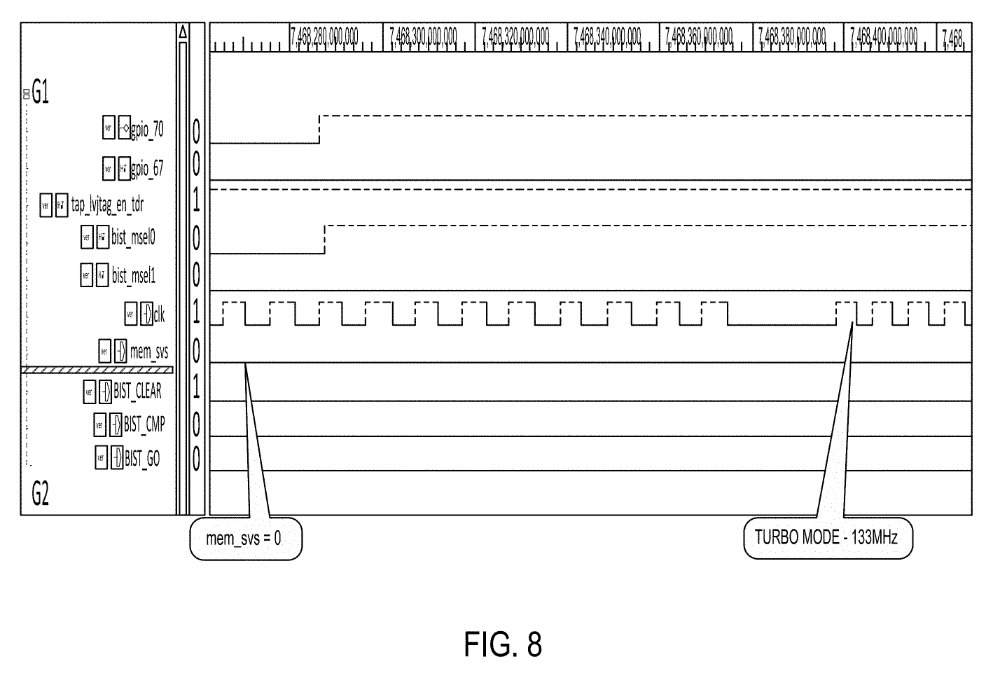

FIG. 8 provides further details of the clock frequency and ACC settings for a turbo mode.

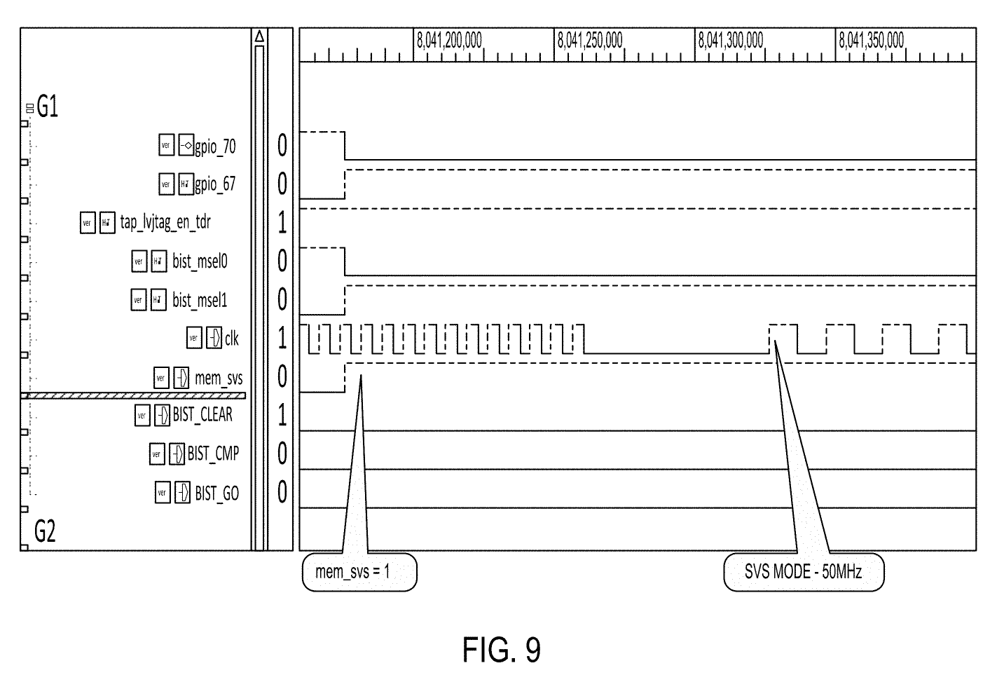

FIG. 9 shows the clock frequency and ACC settings for a SVS mode test.

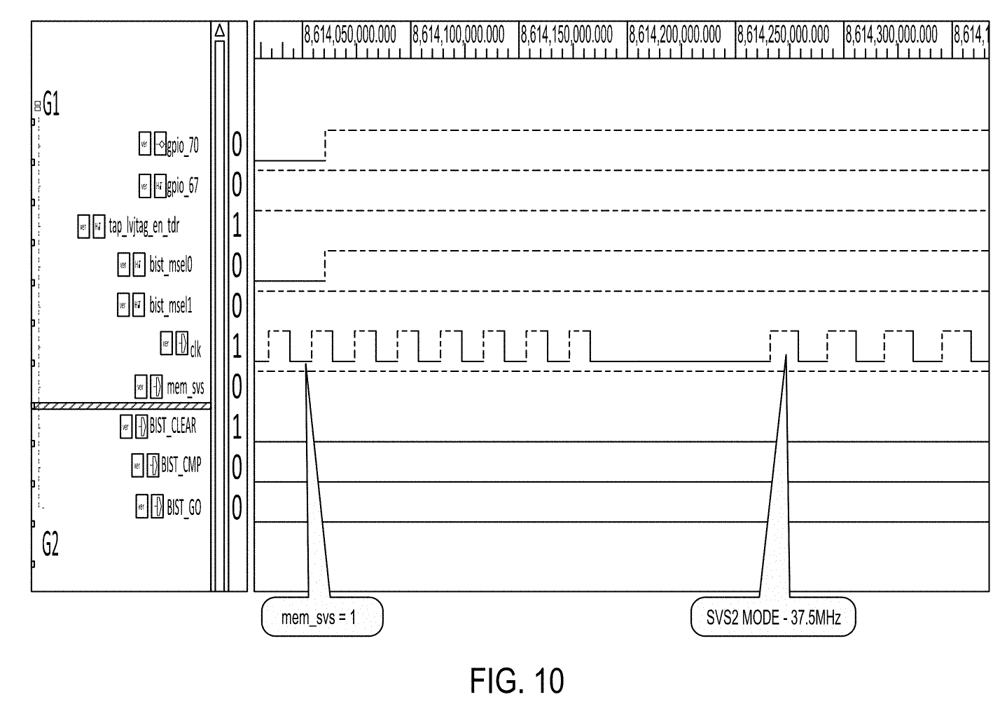

FIG. 10 depicts the clock frequency and ACC settings for a SVS2 mode test.

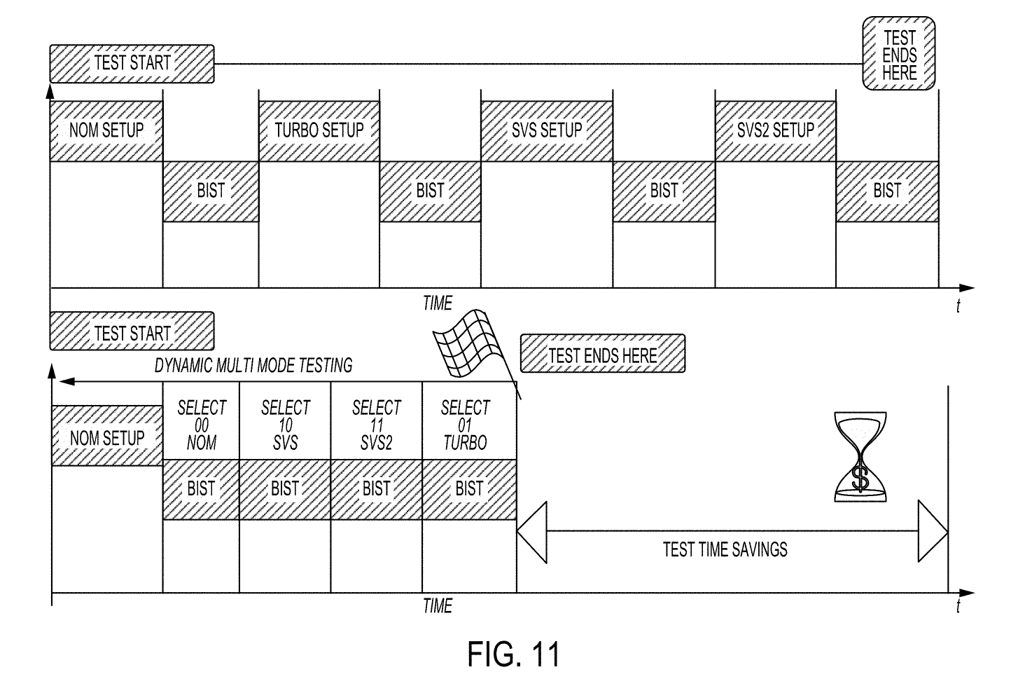

FIG. 11 shows the test time savings that may be achieved with the dynamic memory mode test apparatus described herein. The current methodology is shown on the top diagram. Before each test may be initiated, a specific test setup procedure is performed. Only after the specific test setup procedure is completed may the memory mode testing for the selected mode be performed. In contrast, the lower diagram graphically shows how the test modes follow directly after one another, with no intervening setup procedure. This dynamic memory mode testing may provide significant time savings.

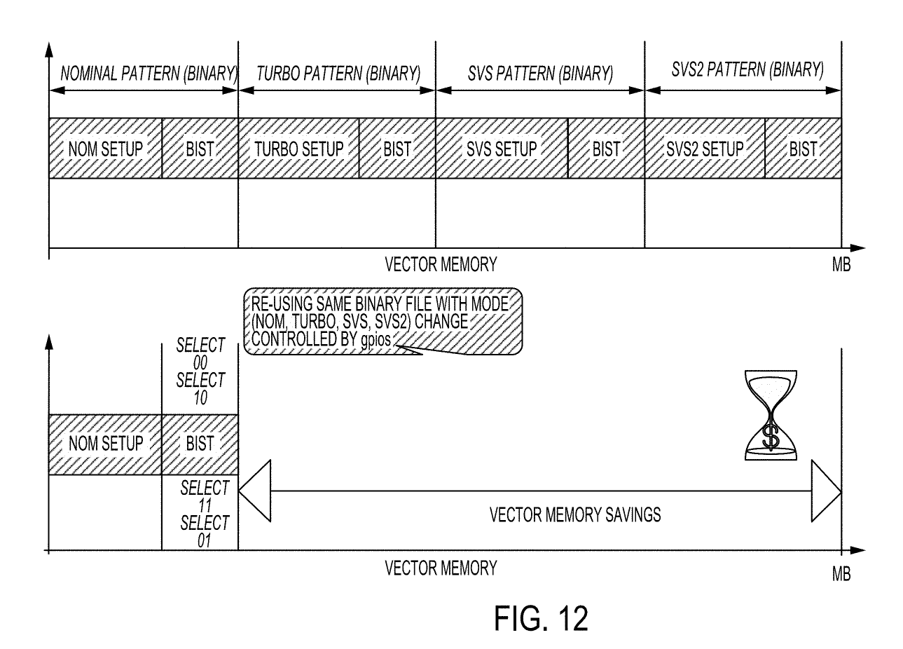

FIG. 12 compares vector memory usage in conventional methods with the vector memory usage in the dynamic memory mode method described herein. In the current method, a test pattern is a binary pattern, with a setup specific to the mode to be tested, followed by the BIST. This dictates vector memory usage for each mode: nominal mode, turbo mode, SVS mode, and SVS2 mode. In contrast, the dynamic memory mode testing described in embodiments herein provides for re-use of the same binary file with BIST mode changes controlled by GPIO 1 and GPIO 2. As shown, logic input to the BIST mode controls the mode selection. The vector memory usage is improved with the dynamic memory mode testing.

The methods and apparatus described above allow implementing real-time test scenarios on ATE for test time reductions and vector memory savings, which may be significant. This is accomplished with a minimal effect on the SoC, as relatively few additional gates per controller are needed for implementation. The GPIOs used in the dynamic memory mode testing may be already available on the SoC or other device to be tested.

A further advantage of the dynamic memory mode testing described herein is that of mimicking an actual use case. Testing methods more reflective of the testing environment may result in failures after devices are installed in end-use devices. Capturing more realistic performance in testing allows for improvements in test quality and reduction in defects.

It is understood that the specific order or hierarchy of blocks in the processes disclosed is an illustration of exemplary approaches. Based upon design preferences, it is understood that the specific order or hierarchy of blocks in the processes may be rearranged. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for dynamic memory testing, comprising:
resetting an electronic device containing a memory to be tested;
selecting a built-in self-test (BIST) mode;
inputting the selected BIST mode to a BIST apparatus;
performing the selected BIST mode and recording test results;
selecting an additional BIST mode; and
switching to the additional BIST mode immediately after completing the selected BIST mode.

2. The method of claim 1, wherein selecting an additional BIST mode selects from a list of BIST modes: nominal mode, turbo mode, static voltage scaling (SVS) mode, and SVS2 mode.

3. The method of claim 2, wherein the SVS2 mode utilizes a lower frequency than the SVS mode.

4. The method of claim 2, wherein the selecting an additional BIST mode continues until all BIST modes have been selected.

5. The method of claim 2, wherein each BIST mode utilizes a different frequency.

6. The method of claim 2, wherein selecting an additional BIST mode utilizes binary logic to indicate which BIST mode is selected.

7. The method of claim 1, wherein inputting the selected BIST mode to a BIST apparatus further comprises inputting the selected BIST mode to a dynamic memory testing (DMT) module.

8. The method of claim 6, wherein inputting the selected BIST mode to a DMT module further comprises:
receiving an input sequence that indicates a frequency division for the selected BIST mode, a test time multiplier (TTM) for the selected BIST mode, and an acceleration (ACC) setting for the selected BIST mode.

9. The method of claim 8, wherein the frequency division required by the selected BIST mode is input in hex form.

10. The method of claim 8, wherein the TTM required by the selected BIST mode is input in one of two hardcoded values.

11. The method of claim 8, wherein the ACC setting is input as one of two digital logic values.

12. An electronic device, comprising:
a clock divider configured to divide a frequency of a clock based on a selected BIST mode;
a built-in self-test (BIST) controller in communication with the clock divider;
a memory in communication with the BIST controller and the clock divider;
a dynamic memory test module in communication with the clock divider, BIST controller, and memory; and
a low voltage test access port in communication with the BIST controller for receiving test outputs from the BIST controller and providing test data output.

13. The electronic device of claim 12, wherein the dynamic memory test module further comprises:
at least two AND gates in communication with at least three multiplexers.

14. The electronic device of claim 13, wherein the at least two AND gates of the dynamic memory test module are in communication with each other and with the at least three multiplexers.

15. The electronic device of claim 12, wherein one of the at least three multiplexers of the dynamic memory test module selects a divider setting for the clock divider to divide a frequency based on the selected BIST mode.

16. The electronic device of claim 12, wherein one of the at least three multiplexers of the dynamic memory test module selects a test time multiplier (TTM), based on one of two input values of the selected BIST mode.

17. The electronic device of claim 12, wherein one of the at least three multiplexers of the dynamic memory test module selects an acceleration (ACC) setting for read/write operations of the selected BIST mode.

18. An apparatus comprising:
means for resetting an electronic device containing a memory to be tested;
means for selecting a built-in self-test (BIST) mode;
means for inputting the selected BIST mode to a BIST apparatus;
means for performing the selected BIST mode and recording test results;
means for selecting an additional BIST mode; and
means for switching to the additional BIST mode immediately after completion of the first BIST mode.

19. The apparatus of claim 18, wherein the means for selecting an additional BIST mode further comprises means for selecting one of BIST modes: nominal mode, turbo mode, static voltage scaling (SVS) mode, and SVS2 mode.

20. The apparatus of claim 19, wherein the means for selecting an additional BIST mode further comprises means for continuing additional BIST mode selections until all BIST modes have been selected.

21. The apparatus of claim 18, further comprising means for inputting the selected BIST mode to a dynamic memory testing module.

22. The apparatus of claim 21, further comprising means for dynamic memory testing, comprising:
means for dividing a frequency for a selected BIST mode;
means for selecting a test time multiplier for the selected BIST mode; and
means for selecting an acceleration setting for the selected BIST mode.

23. A non-transitory computer-readable medium, containing instructions, which when executed cause a processor to perform the following steps:
resetting an electronic device containing a memory to be tested;
selecting a built-in self-test (BIST) mode;
inputting the selected BIST mode to a BIST apparatus;
performing the selected BIST mode and recording test results;
selecting an additional BIST mode; and
switching to the additional BIST mode immediately after completion of the selected BIST mode.

24. The non-transitory computer-readable medium of claim 23, wherein the instruction for selecting a BIST mode selects one of: nominal mode, turbo mode, static voltage scaling (SVS) mode, and SVS2 mode.

25. The non-transitory computer-readable medium of claim 23, further comprising instructions for: continuing to select additional BIST modes until all BIST modes have been selected.

26. The non-transitory computer-readable medium of claim 23, wherein the instructions cause the selected BIST mode to be input to a dynamic memory testing module.

27. The non-transitory computer-readable medium of claim 26, wherein the instructions cause the dynamic memory test module to: determine a frequency division for the selected BIST mode, determine a test time multiplier (TTM) for the selected BIST mode, and determine an acceleration (ACC) setting for the selected BIST mode.
